(19) United States
(12) Patent Application Publication
(10) Pub. No.: US 2007/0131075 A1
(43) Pub. Date: Jun. 14, 2007

(54) SAW BLADE CLAMP MECHANISM

(75) Inventors: Shisong Zhang, Suzhou (CN); Xiangqing Li, Suzhou (CN)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Positec Power Tools (Suzhou) Co. Ltd., Suzhou (CN)

(21) Appl. No.: 11/608,958

(22) Filed: Dec. 11, 2006

(30) Foreign Application Priority Data
Dec. 13, 2005 (CN) 200510022559.5

(51) Int. Cl. B23D 51/10

(52) U.S. Cl. 83/699.21; 83/698.11

(57) ABSTRACT

A saw blade clamp mechanism includes a body forming a channel for receiving a saw blade, a clamping member movably mounted to the body for selectively engaging the saw blade, a releasing member in operative coupling with the clamping member, and a biasing element arranged between the body and the releasing member. A sliding rail is formed on at least one outer side surface of the body. The releasing member has a U-shape having an arm forming a protruding portion rotatably and movably received in the sliding rail. The movement of the releasing member along the sliding rail with respect to the body against the biasing element causes the clamping member to secure and/or release the saw blade. The sliding rail has at least one open end to easily receive the protruding portion of the releasing member so as to facilitate mounting/dismounting of the releasing member on the body.

### BACKGROUND OF THE INVENTION

1. Field of the Invention

The present invention relates to a saw blade clamp mechanism, and in particular to a saw blade clamp mechanism that can be assembled in an efficient manner.

2. The Related Arts

A saw blade clamp mechanism is provided in jigsaw or the likes to secure a saw blade. An example of the saw blade clamp mechanism is illustrated in U.S. Pat. No. 5,987,758, which discloses a saw blade clamp mechanism comprising a body having a blade receiving channel, biasing means connected to a release member and a pair of long linkages, and a clamping member supported by the linkages and the release member. The clamping member is movable in an inclined track formed in the body. The saw blade clamp mechanism includes a variety of components and is thus complicated in construction.

Also, U.S. Pat. No. 6,101,726 discloses a saw blade clamp mechanism, comprising a body having a blade receiving channel, a retaining member that is movable towards the receiving channel by virtue of biasing means, a releasing means forcing the retaining member away from the receiving channel. The releasing means overcomes the force of the biasing means to have the saw blade clamped or released by the clamping member. In this known saw blade clamp mechanism, the releasing means has two rotating arms, which must be made of flexible material for elastic deformation/distortion to facilitate fitting end portions of the releasing means to a fixed pin that is disposed on one end of the body. During such a process of mounting the releasing means with elastic deformation of the rotating arms, the rotating arms are prone to damage and breaking caused by inappropriate handling. This clearly increases manufacture costs and also leads to poor productivity.

Further, an elongate slot is formed in a middle portion of each rotating arm and the clamping member slides along the elongate slot. The rotating arms are often operated under great forces and are thus easy to invalidate because of distortion and deformation caused by the great forces.

Thus, it is desired to have a saw blade clamp mechanism that overcomes the drawbacks of the prior art discussed above.

### SUMMARY OF THE INVENTION

It is an object of the present invention to provide a saw blade clamp mechanism that can be efficiently and easily assembled.

It is another object of the present invention to provide a saw blade clamp mechanism that has a simple structure and thus low costs.

It is a further object of the present invention to provide a saw blade clamp mechanism in which a rigid releasing member is employed so that the service life of the clamp mechanism is effectively extended.

In accordance with the present invention, these objects are realized by a saw blade clamp mechanism, which comprises, a body having a channel for receiving a saw blade, a clamping member movably mounted to the body for selectively clamping the saw blade, a releasing member in operative coupling with the clamping member, and a biasing means arranged between the body and the releasing member. The body forms an inclined track. The clamping member is operatively driven by the releasing member to slide along the inclined track so as to clamp and/or release the saw blade. A sliding rail is formed on at least one outer side surface of the body. The releasing member has a generally U-shape having at least one arm forming a protruding portion rotatably and movably received in the sliding rail. Therefore, the releasing member is allowed to rotate and slide with respect to the body against a biasing force of the biasing means.

Preferably, the releasing member comprises two arms each having a free end portion, and the protruding portion is formed on the opposite inner side of the free end portion. Two opposite outer side surfaces of the body are both provided with the sliding rail. The protruding portions are slidable along the sliding rails respectively. The sliding rail is extended upwardly in an inclined manner from a bottom of the body towards the inclined track and has a first end adjacent to the side wall of the body and a second end adjacent to the inclined track. At least one of the first and second ends is an open end. Preferably, the first end of the sliding rail is an open end. Additionally and alternatively, the second end is an open end. The axis of the sliding rail intersects with an axis of the inclined track. A pin is disposed on the body on which the biasing means is mounted. The biasing means is disposed between the body and the releasing member and has a connecting portion fixed to a protruding ear extending from the arm. A hole is defined in the releasing member for rotatably receiving and retaining the clamping member.

The clamp mechanism of the present invention is applicable to a jigsaw.

Compared with the prior art, the advantage of the present invention is that: the protruding portions are formed on the free end portions of the releasing member and rotatably and movably engaging the sliding rails formed on the outer side surfaces of the body. It is convenient for an operator to mount the releasing member to the body by simply fitting the protruding portions into the sliding rails through open ends of the rails. A hole is defined in a middle portion of the releasing member and rotatably receives the clamping member. The component is of highly rigidity and is thus structural tough against damage such as breaking. Further, because of open ends of the sliding rail, the releasing member is mountable to the sliding rail of the body without elastic deformation/distortion. The releasing member can thus be made of a rigid material, such as metals, and life span is prolonged. Thus, productivity of the clamp mechanism can be enhanced with reduced flaw rate of the product.

### BRIEF DESCRIPTION OF THE DRAWINGS

Details of the present invention will be further described combined with the drawing and the preferred embodiment.

FIG. 1 shows an exploded view of saw blade clamp mechanism constructed in accordance with a preferred embodiment of the present invention;

FIG. 2 shows a side elevational view of saw blade clamp mechanism of the present invention after being assembled to a jigsaw;

FIG. 3 shows a top view of the saw blade clamp mechanism of the present invention;

FIG. 4 shows a cross-sectional view of the saw blade clamp mechanism of the present invention with a saw blade clamped thereto; and

FIG. 5 shows a cross-sectional view similar to FIG. 4 but with the saw blade released.

### DETAILED DESCRIPTION OF THE PREFERRED EMBODIMENT

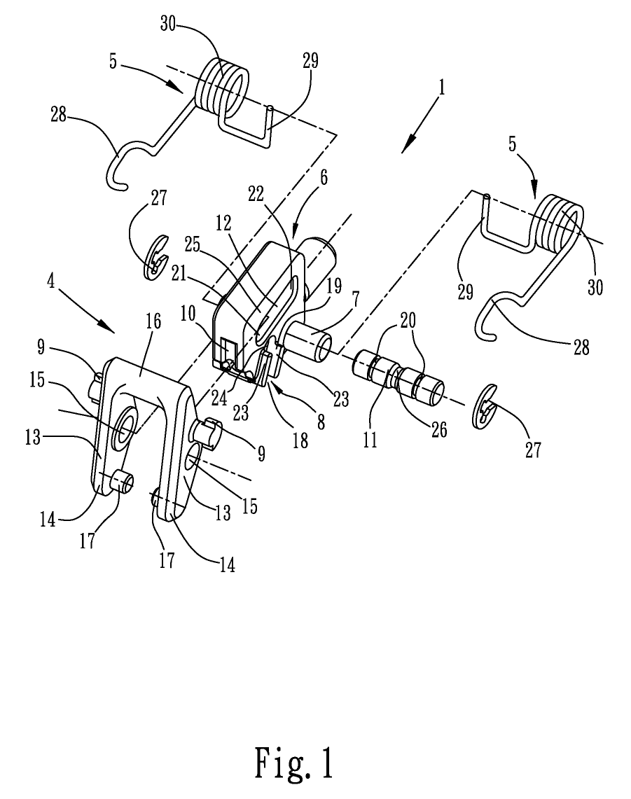

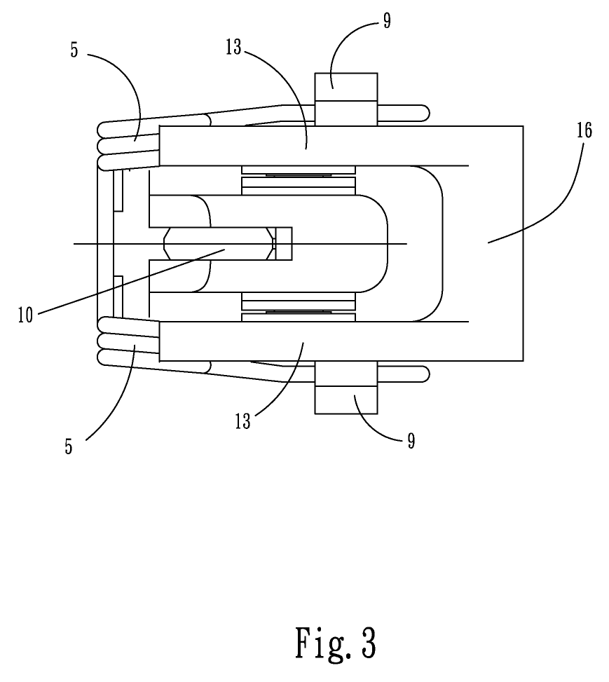

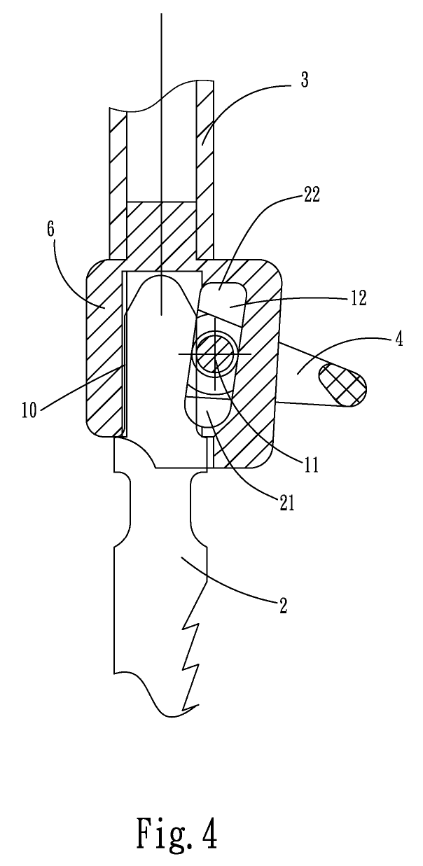

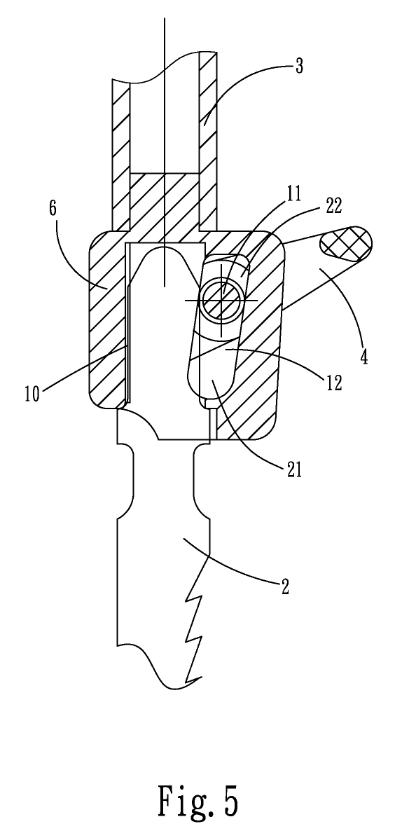

With reference to FIGS. 1-5, a saw blade clamp mechanism constructed in accordance with the present invention, generally designated with reference numeral 1, is shown. The saw blade clamp mechanism 1 is coupled to a jigsaw (not shown) and function to releasably secure a saw blade. Structural details of the jigsaw and the saw blade are known and constitute no novel part of the present invention so that a description of the jigsaw and the saw blade will be omitted, except for those necessary for describing the clamp mechanism 1 of the present invention. Although the clamp mechanism 1 of the present invention is demonstrated herein to secure a saw blade of a jigsaw, it is apparent that the clamp mechanism 1 is also applicable to other tools, such as a reciprocating saw, or the likes.

The clamp mechanism 1 comprises a body 6, which is mounted to a reciprocating rod 3 of the jigsaw. The saw blade, which is broadly designated with reference numeral 2, is releasably secured to the jigsaw by being selectively clamped by the saw blade clamp mechanism 1. Preferably, the body 6 is mounted to the reciprocating rod 3 by fitting a projected portion (not labeled) thereof into a bore (not labeled) defined in the reciprocating rod 3 along an axis of the reciprocating rod 3.

The body 6, which is substantially rectangular in shape, has a longitudinal axis, which, in the embodiment illustrated, is parallel to the direction in which the projected portion of the body 6 fit into the bore of the reciprocating rod 3. In other words, the longitudinal axis is parallel to or, alternatively, coincident with the axis of the reciprocating rod 3. A receiving channel 10 is formed in a longitudinal end of the body 6 and extending longitudinally, serving to receive an end portion (not labeled) of the saw blade 2 in the longitudinal direction. The receiving channel 10 has a converging width that gradually decreases in the longitudinal direction for easy receipt of the saw blade 2 into the receiving channel 10.

The body 6 also forms therein a track 12 extending through opposite side surfaces 25 of the body 6. The track 12 is inclined with respect to the axis of the reciprocating rod 3 (or the longitudinal direction of the receiving channel 10), and in communication with the receiving channel 10. A clamping member 11, in the form of an elongate pin, extends through the track 12 and is movable along the track 12. The inclined track 12 has a proximal end 21 that is adjacent to the receiving channel 10 and an opposite distal end 22 that is away from the receiving channel 10. With the saw blade 2 received in the receiving channel 10, a movement of the clamping member 11 along the track 12 from the distal end 22 to the proximal end 21 brings the clamping member 11 towards the saw blade 2 and eventually engages and clamps the saw blade 2 in the receiving channel 10. On the other hand, when the clamping member 11 is moved from the proximal end 21 to the distal end 22, the clamping member 11 disengages from and thus releases the saw blade 2.

A sliding rail 8 is formed on the side surface 25 of the body 6 and is inclined with respect to the inclined track 12 so that an extension of an axis of the sliding rail 8 intersects an axis of the track 12. In the embodiment illustrated, the sliding rail 8 is delimited by two spaced sidewalls 23 formed on and substantially perpendicular to the side surface 25. The rail 8 provided by the sidewalls 23 extending through the body 6 serves as a track for guiding movement of a releasing member 4 with respect to the body 6. Between the sidewalls 23, an open slot 24 is formed and has a predetermined depth. The sliding rail 8 has, along the axis thereof intersecting the track 12, a first end 18 adjacent to the opening portion of the receiving channel 10 and an opposite second end 19 adjacent to the inclined track 12.

The releasing member 4 is generally U-shaped, comprising two spaced arms 13 and an operating portion 16 connected between the two arms 13. The arms 13 have free end portions 14 away from the operating portion 16 and spaced from and opposite to each other. The free end portions 14 of the arms 13 are provided with inward-extending protruding portions 17, which are symmetrically formed on opposite inner surfaces of the free end portions 14 and co-axial with each other. The protruding portions 17 are received in the sliding rails 8 on the opposite side surfaces 25 of the body 6 by being inserted through an opening of the first end 18 (or the second end 19) of the sliding rail 8 whereby the releasing member 4 is slidably received through the first end 18 (or the second end 19) of the sliding rail 8 to couple to the body 6 without causing any elastic distortion or deformation of any portion thereof. Damage that is likely caused by the deformation of the releasing member 4 is thus eliminated.

Further, since the releasing member 4 is mounted to the body 6 by moving the protruding portions 17 along the sliding rails 8 on the side surfaces 25 of the body 6, which ensures no deformation or distortion of the releasing member 4, the releasing member 4 may be made of a rigid material, such as metals, for example steel, to provide enhanced structural stability and strength. In the embodiment illustrated, the releasing member 4 comprises two symmetrical arms 13, and for those skilled in the art, it would be easy to think that the releasing member 4 may comprise only one single arm 13 having a portion slidably mounted in a corresponding sliding rail 8.

The releasing member 4 is coupled to the body 6 so that the arms 13 are located outside the side surfaces 25 of the body 6. The protruding portions 17 are generally cylindrical and are thus rotatable about the common axis thereof and slidable along the sliding rail 8 so as to cause relative movement and/or rotation of the arms 13 with respect to the surfaces 25 of the body 6. Aligned holes 15 are formed in middle portions of the opposite arms 13, and the holes 15 have a diameter substantially corresponding to a cross-sectional dimension of the clamping member 11, for rotatably receiving and retaining the clamping member 11 therein. With the protruding portions 17 serving as a rotational center, the arms 13 is rotatable with respect to the body 6 and the rotation (or combination of rotation and linear movement along the rails 8) causes the clamping member 11 that is retained in the holes 15 to move along the track 12.

As mentioned above, the clamping member 11 extends through both the holes 15 defined in the arms 13 of the releasing member 4 and the inclined track 12 of the body 6. Thus, the clamping member 11 is rotatable with respect to the holes 15 and is movable along the track 12 between two positions corresponding to the proximal and distal ends 21, 22. In the first position of the track 12, the clamping member 11 is away from the receiving channel 10 and located in the distal end 22 of the inclined track 12; and in the second position, the clamping member 11 is close to the receiving channel 10 and located in the proximal end 21 of the inclined track 12.

In the embodiment illustrated and as mentioned above, the clamping member 11 is in the form of a pin. Two circumferential grooves 20 are formed on an outer cylindrical surface (not labeled) of the pin-like champing member 11 and the grooves 20 are located outside the arms 13 of the releasing member 4 to receive and engage two clip rings 27 respectively. The clip rings 27 secure the clamping member 11 to the releasing member 4 and the body 6 so that the clamping member 11 does not separate from the body 6 and the releasing member 4.

A middle section of the pin-like clamping member 11 is reduced in diameter so as to form, in the outer cylindrical surface thereof, a trapezoid slot comprising a diameter-reduced cylindrical surface 26 and two opposite conic surfaces connecting the cylindrical surface 26 to the outer cylindrical surface of the pin 11. With the saw blade 2 received in the receiving channel 10, movement of the clamping member 11 along the track 12 from the distal end 22 to the proximal end 21 brings the clamping member 11 towards the saw blade 2 and fitting the trapezoid slot over an edge of the saw blade 2, eventually causing the cylindrical surface 26 of the clamping member 11 to tightly engage the edge the saw blade 2 to thereby secure the saw blade 2.

Biasing means 5 is arranged between the releasing member 4 and the body 6 to provide a basing force between the releasing member 4 and the body 6, which retains the releasing member 4 on the body 6 and also maintains the clamping member 11 in position with respect to the track 12 and the body 6 so that change of the position of the releasing member 4 along the track 12 must be done by overcoming the biasing force of the biasing means 5.

To retain the biasing means 5, two pins 7 are formed, preferably in a symmetric manner, on the side surfaces 25 of the body 6 at a location away from the sliding rail 8, and two ears 9 are formed on the arms 13 of the releasing member 4 and extending outward. The ears 9, as illustrated, have a disc-shape forming an expanded end. Preferably, the ears 9 are located close to the operating portion 16 of the releasing member 4.

In the embodiment illustrated, the biasing means 5 comprises two torsion springs located on opposite sides of the releasing member 4 respectively. Each torsion spring has a coil-like main body 30, a first connecting portion 28 and a second connecting portion 29. The main body 30 is sleeved over the pin 7 of the body 6. The first connecting portion 28 is hooked with the ear 9 of the releasing member 4. The second connecting portion 29 forms a hook that is fit over and thus attached to one edge or end portion of the body 6 at a location adjacent to the sliding rail 8 of the body 6. For those skilled in the art, it would be easy to know that a single torsion spring for biasing the releasing member 4 is also possible. The biasing means 5 may also comprise any other member that provides a biasing against the clamping member 11, such as an extension spring and a compression spring.

To assemble the saw blade clamp mechanism 1, the free end portions 14 of the releasing member 4 are initially aligned with the first ends 18 of the sliding rails 8 on opposite side surfaces 25 of the body 6. The protruding portions 17 are then fit into the sliding rails 8 through the first ends 18 and the releasing member 4 is moved along the sliding rail 8 from the first end 18 with simultaneous rotation of the operating portion 16 to align the holes 15 of the arms 13 with the inclined track 12 of the body 6. With the holes 15 aligned with the track 12, the clamping member 11 is inserted from one of the holes 15 and extending through the inclined track 12 and the other hole 15 of the releasing member 4 to thereby temporarily retain the releasing member 4 on the body 6.

The coil-like main bodies 30 of the torsion springs of biasing means 5 are then fit over the pins 7, which are protruded from the two outer side surfaces 25 of the body 6, respectively, and the first connecting portions 28 of the torsion springs of the biasing means 5 are hooked on the protruding ears 9 of the releasing member 4 and the second connecting portions 29 of the biasing means 5 are attached to the end portion of the body 6 at locations adjacent to the sliding rail 8. In the embodiment illustrated, the biasing means 5 are two torsion springs that are symmetrically connected with the body 6 and releasing member 4.

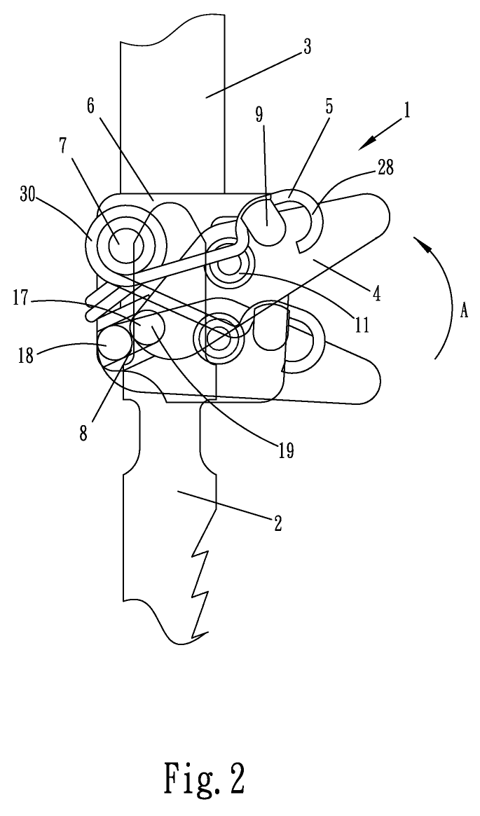

Referring to FIGS. 2-4, to assemble the saw blade 2 to the body 6 of the clamp mechanism 1, the operating portion 16 of the releasing member 4 is first moved against the biasing force of the biasing means 5 in the direction indicated by arrow A of FIG. 2. The protruding portions 17 of the free end portions 14 of the releasing member 4 are moved along the sliding rails 8 of the body 6 and are simultaneously rotated about the common axis thereof. At this time, the clamping member 11 that is positioned in the holes 15 of the releasing member 4 are rotated and moved by the releasing member 4 along the track 12 from the proximal end 21 to the distal end 22. Thus, the receiving channel 10 is opened and the saw blade 2 is allowed to insert into the receiving channel 10. When the end portion of the saw blade 2 reaches the bottom of the receiving channel 10, the releasing member 4 is released and the biasing force of the biasing means 5 causes the clamping member 11 to move from the distal end 22 to the proximal end 21 to thereby engage and thus clamp the saw blade 2.

To release the saw blade 2 from the body 6 of the clamp mechanism 1, the operating portion 16 of the releasing member 4 is again operated in the direction indicated by arrow A against the biasing force of the biasing means 5. The clamping member 11 is then moved from the proximal end 21 to the distal end 22 to disengage from the saw blade 2 and consequently, the saw blade 2 is released from the receiving channel 10. When the saw blade 2 is released from the body 6, the first connecting portions 28 of the biasing means 5 would press the ears 9 of the releasing member 4 and thus the clamping member 11 is forced back to the proximal end 21 of the inclined track 12.

The present invention is particularly suitable for clamping a saw blade to a jigsaw. The protruding portions 17 on the free end portions 14 of the arms 13 of the U-shaped releasing member 4 in combination of the sliding rails 8 that have at least one open end (either end 18 or 19) allows for easy ad efficient assembling of the releasing member 4 to the body 6 without elastic deformation/distortion of any portion of the releasing member 4 and/or the body 6. As a consequence, the releasing member 4 can be made of a rigid material, such as metals, and the life span is prolonged. Product flaw rate in the manufacturing of the clamp mechanism caused by inappropriate assembling can be reduced and productivity enhanced. Further, fewer components are needed for the clamp mechanism of the present invention, and the structure is simplified.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A saw blade clamp mechanism comprising:
a body defining a channel adapted to receive a saw blade, the body also defining a track;
a clamping member slidably received in the track and movable between a first position where the clamping member disengages from and thus release the saw blade and a second position where the clamping member engages and thus secures the saw blade;
a releasing member movably mounted to the body and in operative coupling with the clamping member for selectively moving the clamping member between the first and second positions;
biasing means arranged between the body and the releasing member to bias the releasing member to move the clamping member to the second position to clamp the saw blade;
wherein a sliding rail is formed on at least one side surface of the body and the releasing member comprises a protruding portion slidably received in the sliding rail, the protruding portion being configured so that the releasing member is rotatable and movable with respect to the body against a biasing force of the biasing means.

2. The saw blade clamp mechanism as claimed in claim 1, wherein the releasing member comprises two arms forming opposite free end portions each forming a protruding portion in opposite inner side thereof and wherein the body has opposite side surfaces each forming one sliding rail slidably receive corresponding protruding portion.

3. The saw blade clamp mechanism as claimed in claim 1, wherein the sliding rail extends upwardly in an inclined manner from an edge of the body and towards the track and has a first end adjacent to the edge of the body and a second end adjacent to the track, at least one of the first and second end being an open end.

4. The saw blade clamp mechanism as claimed in claim 3, wherein the first end of the sliding rail is an open end.

5. The saw blade clamp mechanism as claimed in claim 4, wherein the second end of the sliding rail is an open end.

6. The saw blade clamp mechanism as claimed in claim 5, wherein the sliding rail has an axis defined by a line connecting the first and second ends, the axis being extended in a direction to intersect with an axis of said inclined track.

7. The saw blade clamp mechanism as claimed in claim 1, wherein the body forms a pin on which a main body of the biasing means is supported.

8. The saw blade clamp mechanism as claimed in claim 7, wherein the biasing means has a connecting portion fixed to a protruding ear extending outward from the releasing member.

9. The saw blade clamp mechanism as claimed in claim 7, wherein the biasing means comprises a torsion spring having a coil-like main body sleeved on the pin.

10. The saw blade clamp mechanism as claimed 9, wherein the torsion spring has a first connecting portion fixed to a protruding ear extending from the releasing member and a second connecting portion forming a hook engaging an edge portion of the body.

11. The saw blade clamp mechanism as claimed in claim 1, wherein the releasing member forms a hole through which the clamping member rotatably extends and retained.

12. The saw blade clamp mechanism as claimed in claim 1, wherein the clamp mechanism is adapted to connect to a portion of a jigsaw.

13. A saw blade clamp mechanism comprising:
a body having an end face and opposite side surfaces, the end face defining a channel adapted to receive a saw blade, an opening being formed through the side surfaces and defining a track in a direction inclined with respect to a longitudinal axis of the body, the track being in communication with the channel, each side surface of the body forming a sliding rail;
a clamping member slidably received in the track and movable between a first position where the clamping member disengages from and thus release the saw blade and a second position where the clamping member engages and thus secures the saw blade;
a releasing member comprising two arms located on opposite sides of the body and opposing the side surfaces of the body, each arm forming a protruding portion extending toward the body and rotatably and movably received in the sliding rail of the body so that the releasing member is rotatably and movably mounted to the body, the releasing member being in operative coupling with the clamping member for selectively moving the clamping member between the first and second positions; and
biasing means arranged between the body and the releasing member to bias the releasing member to move the clamping member to the second position to clamp the saw blade.

14. The saw blade clamp mechanism as claimed in claim 13, wherein the sliding rail extends upwardly in an inclined manner from an end portion of the body and towards the track and has a first end adjacent to the end portion of the body and a second end adjacent to the track, at least one of the first and second end being an open end.

15. The saw blade clamp mechanism as claimed in claim 14, wherein the first end of the sliding rail is an open end.

16. The saw blade clamp mechanism as claimed in claim 15, wherein the second end of the sliding rail is an open end.

17. The saw blade clamp mechanism as claimed in claim 16, wherein the sliding rail has an axis defined by a line connecting the first and second ends, the axis being extended in a direction to intersect with an axis of said inclined track.
